(19) United States
(12) Patent Application Publication
(10) Pub. No.: US 2004/0021468 A1
(43) Pub. Date: Feb. 5, 2004

(54) Battery test system

(75) Inventors: Thomas J. Dougherty, Waukesha, WI (US); Ronald C. Miles, Milwaukee, WI (US)

Correspondence Address: Scott M. Day, Foley & Lardner, Suite 3800, 777 East Wisconsin Avenue, Milwaukee, WI, 53202-5306, US

(73) Assignee: Johnson Controls Technology Company

(21) Appl. No.: 10/449,820

(22) Filed: May 30, 2003

Related U.S. Application Data
(60) Provisional application No. 60/384,491, filed on May 31, 2002.

(51) Int. Cl. G01N 27/416

(52) U.S. Cl. 324/429

(57) ABSTRACT

An apparatus and method for determining whether a load test was properly conducted by a battery charger-tester and whether a battery was properly charged by the battery charger-tester are disclosed. The apparatus and method provide for a control system for controlling battery voltage during the testing, a tester for conducting a series of tests on the battery, and a charger for providing a charging current to the battery.

### CROSS-REFERENCE TO RELATED PATENT APPLICATIONS

This application claims the benefit of U.S. Provisional Patent Application No. 60/384,491 (“BATTERY TEST SYSTEM”) filed May 31, 2002 and entitled “Battery Test System,” the disclosure of which is incorporated herein by reference in its entirety.

### FIELD

The present invention relates generally to the field of battery test systems. More specifically, the present invention relates to a system for determining whether a battery load test was properly conducted and whether a battery was properly charged by a battery charger-tester.

### BACKGROUND

A vehicle (e.g., an automobile, truck, etc.) includes a battery (e.g., a lead-acid storage battery) that provides power for starting the vehicle and for operating various vehicle systems. Such a vehicle also includes an alternator that charges the battery when the vehicle is running so that the battery maintains a sufficient charge for these purposes.

For various reasons (e.g., power drain on the battery when the vehicle is not running), the capacity of a battery may become diminished, such that the battery exhibits a reduced ability to provide the power necessary to start the vehicle and/or operate various vehicle systems. It may therefore be helpful to use a separate charging device to recharge the battery and return it to its full or near full capacity for subsequent use.

It may be desirable to test the battery prior to recharging it to ensure that one or more cells in the battery are not defective, which may make recharging the battery difficult. Conventional battery testers utilized for this purpose include light load testers, heavy load testers, and conductance testers. Light and heavy load testers typically connect a resistive load to a battery for a period of time in order to draw a relatively light or heavy battery current, respectively. Load testers may be used when it is desirable to draw battery current during testing. Unlike load testers, conductance testers are passive in that they do not draw an appreciable current from a battery being tested. Thus, conductance testers may be used to analyze batteries at a relatively low state of charge.

Batteries may be analyzed by battery testers using multiple battery tests. Known testers fail to carry out a load test (or a step of a load test) while still providing a result (e.g., test passed or failed, battery “good” or “bad,” etc.). In addition, conventional battery testers capable of charging batteries as part of the test do not always provide a proper charge. Accordingly, it would be advantageous to provide a system for determining whether a battery load test was properly conducted by a battery charger-tester and whether a battery was properly charged by the battery charger-tester.

It would be advantageous to provide a battery test system of a type disclosed in the present application that provides any one or more of these or other advantageous features.

### SUMMARY

The present invention relates to a method for determining whether a battery load test was properly carried out for a battery. The method comprises determining whether a load was properly applied to the battery during the load test and determining whether the battery was properly charged during the load test.

Another embodiment of the present invention relates to an apparatus for analyzing a battery load test. The apparatus comprises a tester for conducting a series of tests on a battery, a charger for providing a charging current to the battery, and a control system having a routine for determining whether a load was properly applied to a battery during the load test and whether the battery was properly charged during the load test.

### BRIEF DESCRIPTION OF THE DRAWINGS

FIG. 1 is a schematic block diagram showing a battery test system according to an exemplary embodiment.

FIG. 2 is a flow diagram showing steps of a test to determine whether a load was properly applied during a load test according to a preferred embodiment.

FIG. 3 is a graph of voltage over time for a battery that passes the test shown in FIG. 2.

FIG. 4 is a graph of voltage over time for a battery that fails the test shown in FIG. 2.

FIG. 5A is a flow diagram showing steps of a test to determine whether a charging current was properly applied to a battery according to an exemplary embodiment.

FIG. 5B is a flow diagram showing steps of a test to determine whether a charging current was properly applied to a battery according to an exemplary embodiment.

FIG. 5C is a flow diagram showing steps of a test to determine whether a charging current was properly applied to a battery according to an exemplary embodiment.

FIG. 6 is a graph of the voltage and charging current over time for a battery that passes the test shown in FIG. 5C.

FIG. 7 is a graph of the voltage and charging current over time for a battery that fails the tests shown in FIGS. 5A and 5B.

### DETAILED DESCRIPTION OF EXEMPLARY EMBODIMENTS

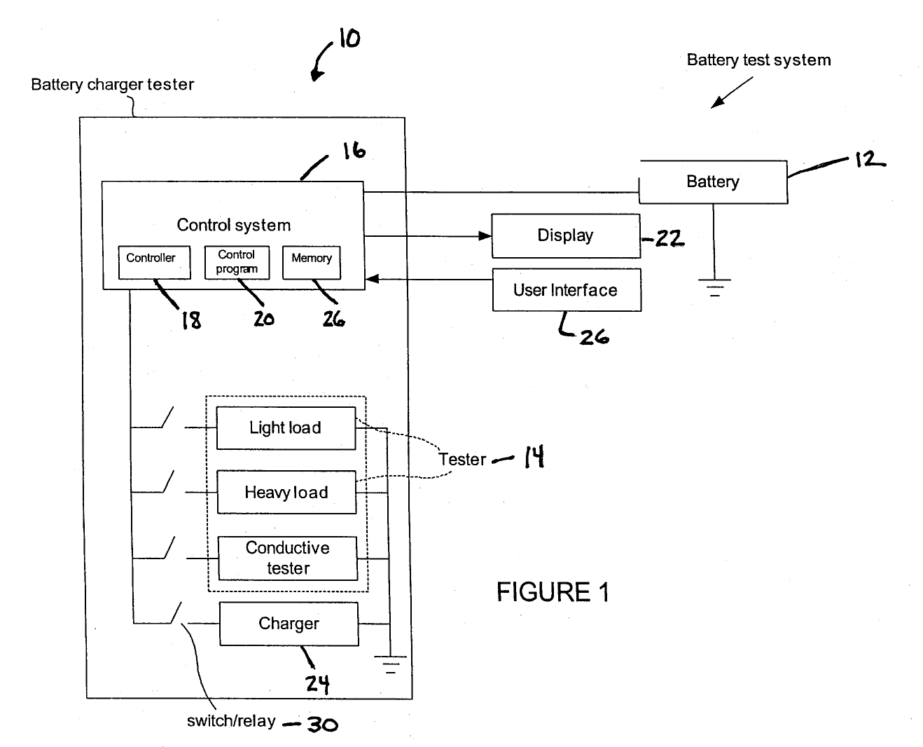

Referring to FIGS. 1 through 7, various exemplary and alternative embodiments of a battery test system intended for testing and charging a battery and conducting a series of tests to determine whether a battery should be fully charged or replaced are shown and described.

A battery test system is shown in FIG. 1 according to an exemplary embodiment. The battery test system includes an apparatus or device 10 such as a battery charger-tester for charging batteries (e.g., lead-acid storage batteries) and conducting a series of tests on the batteries. Apparatus 10 includes a battery 12, a tester 14, a control system 16, a charger 24, and user interface 26.

According to an exemplary embodiment, the apparatus is a battery charger-tester of the type disclosed in U.S. Pat. No. 6,144,185 titled “Method and Apparatus for Determining the Condition of a Battery Through the Use of Multiple Battery Tests” issued Nov. 7, 2000, which is hereby incorporated by reference. According to a particularly preferred embodiment, the battery charger-tester is the PowerLogic battery charger-tester commercially available from Midtronics, Inc. of Willowbrook, Ill.

As shown in FIG. 1, battery 12 is coupled to apparatus 10. The battery utilized in conjunction with apparatus 10 may be any type of battery or power source. According to a particularly preferred embodiment, the battery is an automotive vehicle battery or battery pack such as a 12V or 36V SLI (starting, lighting and ignition) battery. The battery may be implemented as three or more 12V batteries connected together. Each 12V battery may be a VRLA (valve regulated lead-acid) battery, and may include any number of batteries according to alternative embodiments. A suitable 12V battery includes an absorbed glass mat (AGM) Optima battery commercially available from Optima Batteries, Inc. of Boulder, Colo. Another suitable 36V battery includes a 2.4 amp hour Inspira battery commercially available from Johnson Controls Battery Group, Inc. of Milwaukee, Wis. Various other types of batteries may be utilized according to other alternative embodiments.

Tester 14 is adapted to conduct tests on battery 12. According to a preferred embodiment, the tests performed by tester 14 include a conductance test, a heavy load test, a light load test, a conductance and load comparison test, and a charge acceptance test.

Control system 16 is configured to selectively run certain battery tests. For example, a controller 18 and memory 26 are included as part of control system 16 to implement a control program 20 that connects and disconnects certain hardware (e.g., resistors, loads, etc.) that can draw current from battery 12 during a load test. The loads are connected and disconnected from the battery by opening and closing a relay or switch 30 (e.g. a MOSFET).

Control system 16 monitors, regulates, and controls parameters and conditions for apparatus 10. Control system 16 may include sensors to monitor conditions of battery 12 (e.g., voltage, current, temperature, etc.) and/or conditions of apparatus 10 (e.g., current applied to charge battery). A signal representative of a condition of battery 12 and/or apparatus 10 may then be provided by the sensor to controller 18.

Controller 18 can utilize inputs (e.g., provided by sensors and/or a user interface) in routines (e.g., calculations, programs, algorithms, logic, etc.). As shown in FIG. 1, a user interface or input device (e.g., keypad, radio frequency input, etc.) is provided (e.g., coupled to control system 16) for providing the inputs utilized in the routines. According to a preferred embodiment, the routines include a “load check” for determining whether a load was applied during a load test period (e.g., light load test, heavy load test, etc.). The routines can determine if the load was not applied, for example, due to a faulty relay or switch. The routines include a “charge check” to determine whether the charging current was applied during a charging period, and whether the battery was brought to a full or complete state of charge. The routines can determine if the charge was not sufficiently applied, for example, due to a faulty relay or switch, failure of the charging circuit, and/or a mechanical connection (e.g., the clamps connecting to the battery may have fallen off).

Controller 18 provides output data (e.g., signals, information, transfers, etc.) relating to battery 12 and the tests performed on battery 12 (based on inputs and routines). The output data from controller 18 may be displayed on a monitor or other device 22 shown as a display. For example, device 22 may indicate that a battery passed certain tests or combinations of tests. According to exemplary embodiments, device 22 may provide any relevant data or information (e.g., charging time, warranty information, etc.) about apparatus 10. The output data can be an actual value monitored and measured by the control system or a prediction generated by the control system. The output data may include a warning signal that indicates the battery is approaching the end of its life or has a low state of charge that would reduce the likelihood of starting a vehicle. The output data may also indicate that further action should be taken after the testing, such as charging, replacement, diagnostics, etc.

Controller 18 may comprise a microprocessor, controller or programmable logic controller (PLC) configured to implement control program 20. According to alternative embodiments, other suitable controllers may be provided. For example, controllers of a type that may include a microprocessor, microcomputer or programmable digital processor, with associated software, operating systems and/or any other associated programs to collectively implement the control program may be provided. According to alternative embodiments, the controller and control program may be implemented in hardware, software, or a combination thereof, or in a central program implemented in any of a variety of forms.

Control system 16 selectively connects and disconnects charger 24 with battery 12 to provide a charging current to battery 12. The charging current may be provided for a relatively short period (e.g., after a load test). If battery 12 passes certain tests as described below, battery 12 is charged for a relatively long period to a full or complete state of charge (e.g., about 12.8 volts to about 13.1 volts at a charging voltage of about 16 volts).

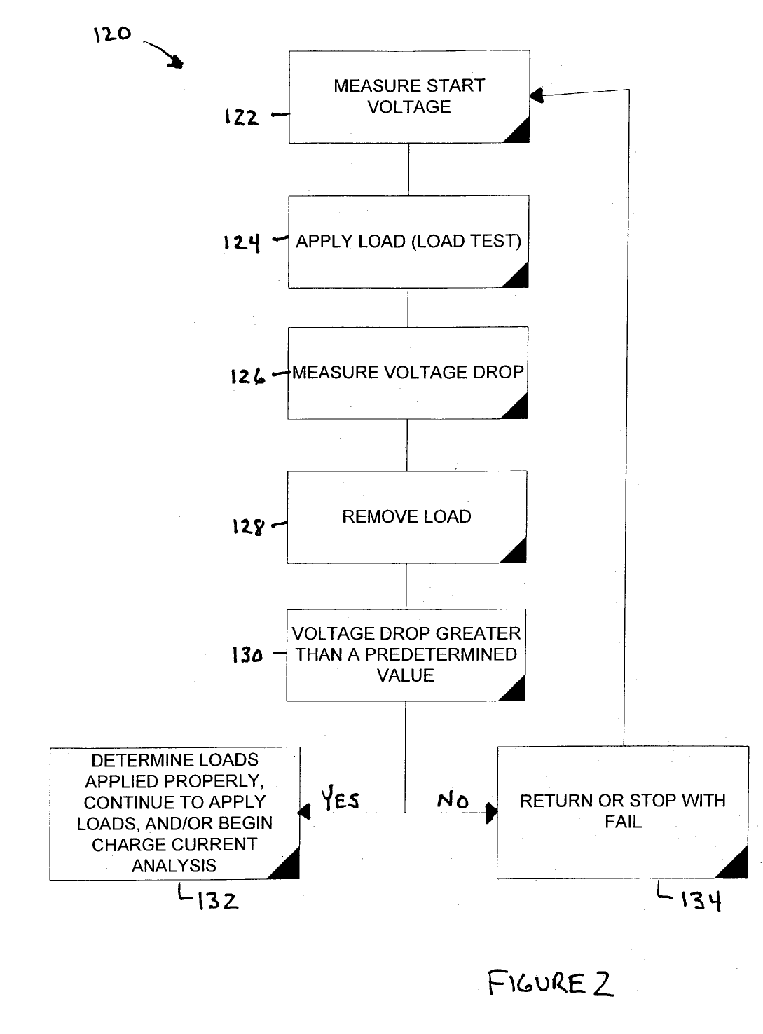

FIG. 2 shows a block diagram of steps of a test or routine 120 to determine whether a load was properly applied during a load test according to a preferred embodiment. According to routine 120, a start voltage (e.g., initial voltage immediately prior to a load being applied) is measured (step 122). This is a value that serves as a reference for determinations made during routine 120. A load is then applied to a battery (step 124). The voltage drop of the battery from the start voltage (i.e., “discharge”) is measured (step 126) by a sensor of the control system. The load is then removed (step 128). The voltage drop can be measured as the difference between the start voltage and the voltage from a point shortly after the load is applied.

To determine if the load was properly applied during the load test period (step 122), the control system measures the voltage drop (e.g., the amount that the voltage drops from the start voltage once the load is applied) (step 126) and calculates (step 130) the drop in voltage from the start voltage. If the drop in voltage after a load is applied is greater than a predetermined value, routine 120 proceeds with additional tests. According to an exemplary embodiment, the predetermined value may be in the range of about 0 to 5.0 volts. According to another alternative embodiment, the predetermined value may be in the range of about 0 to 1.0 volts. According to a preferred embodiment, the predetermined value is about 0.5 volts.

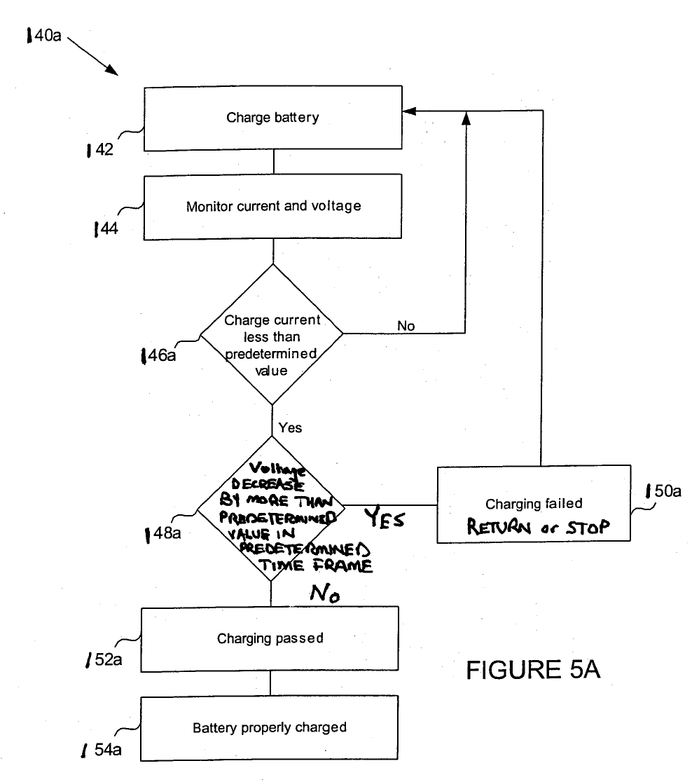

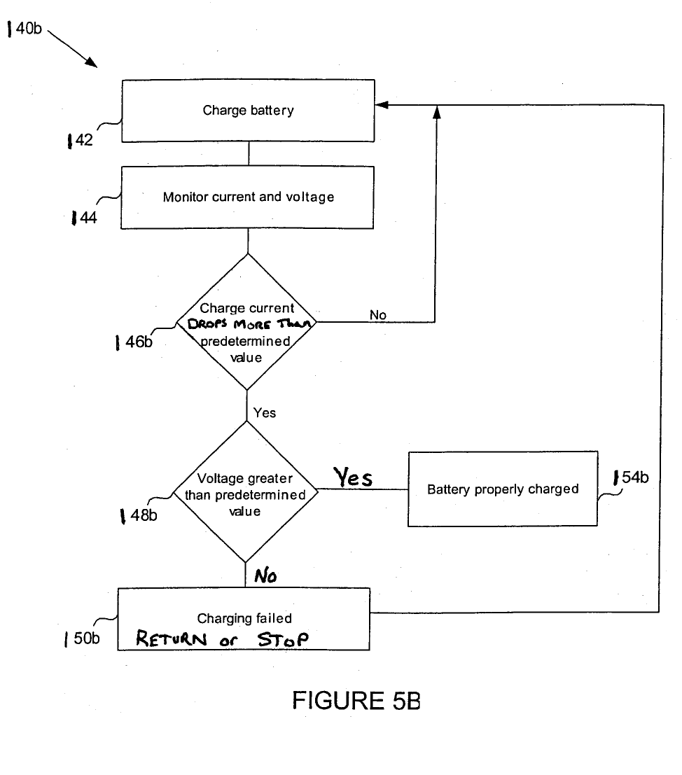

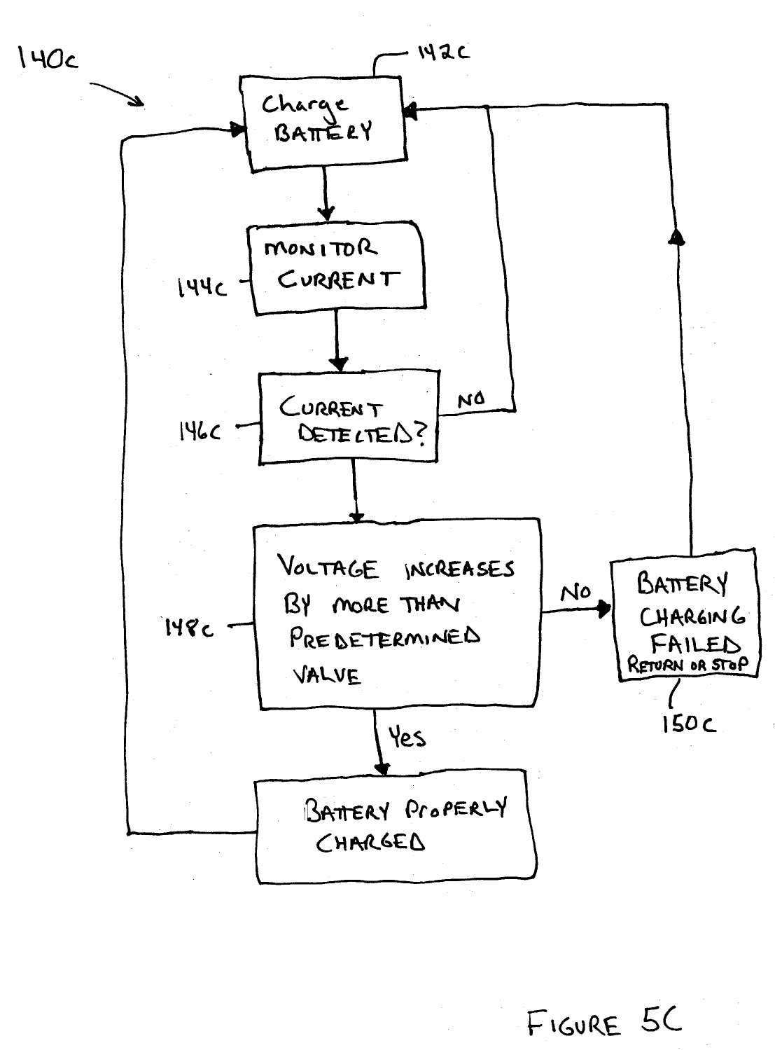

The control system applies additional load tests, determines that the load was properly applied, and/or begins routines 140a and/or 140b shown on FIGS. 5A and 5B to determine whether the battery was properly charged during the load test (step 132). If the drop in voltage after a load is applied is less than the predetermined value, the control system reapplies the load or stops routine 120 indicating that the load was not applied properly during the load test (step 134). Typically, the control system can return to the beginning of routine 120 to reapply a load several times. According to a preferred embodiment, the control system returns to the beginning of routine 120 one time before stopping routine 120 and determining the load was not applied properly.

According to an alternative embodiment, the control system is configured to determine whether the applied load was greater than a predetermined value (e.g., greater than about 50 amps, and more preferably greater than about 100 amps). This type of determination allows the control system to identify certain situations where a load is not properly applied. For example, a 100 amp load may be applied to the battery, but for some reason may not draw the full 100 amps. By determining the amount of draw from the load, the control system can confirm whether the load is being applied properly or even being applied at all.

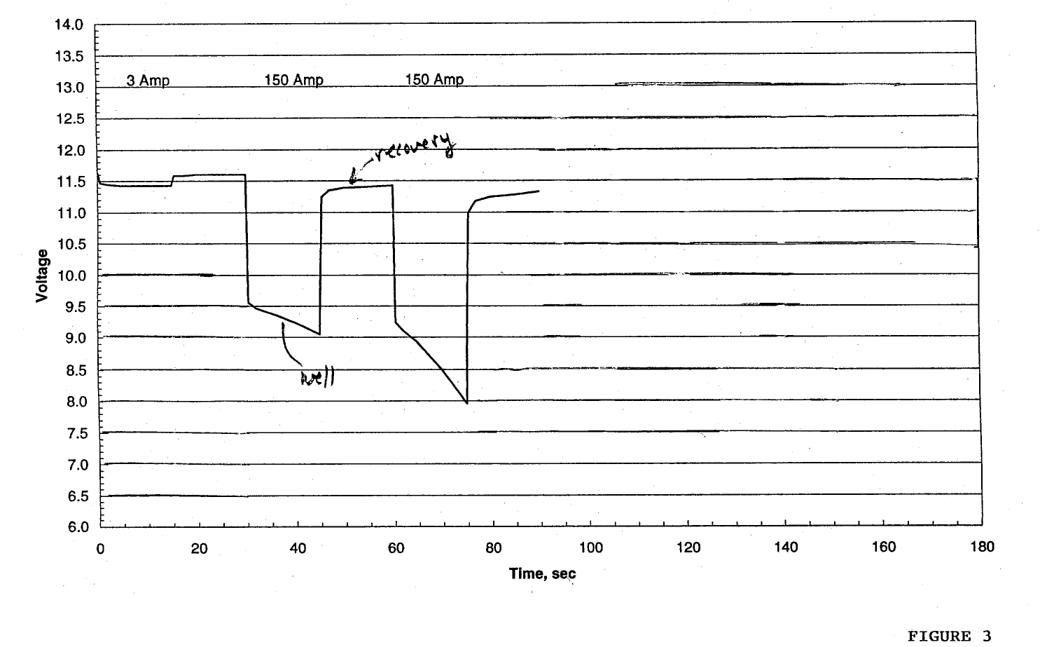

FIG. 3 provides an example of how routine 120 may be carried out on a battery. Referring to FIG. 3, a battery is shown undergoing charging and discharging from the battery charger-tester. Between 0 and about 15 seconds, a relatively light load (e.g., 3 amps) is applied to the battery by apparatus 10 (e.g., the battery is “discharged”). The voltage of the battery is shown dropping from a start voltage of about 11.6 volts to about 11.4 volts during this period. From about 15 to 30 seconds, the battery “relaxes” or recovers after the load is removed to a voltage of about 11.6 volts. In the illustrated example, the voltage drops about 0.2 volts (e.g., 11.6−11.4=0.2 volts). Since the voltage drop is less than the preferred predetermined value of 0.5 volts, routine 120 returns to the beginning to measure the start voltage so that the control system can apply additional loads for further testing.

Between about 30 and 45 seconds, a relatively heavy load (e.g., 150 amps) is applied to the battery. During this period, the voltage of the battery is shown decreasing (shown as a “well”) from a start voltage of about 11.6 volts (e.g., at about 30 seconds). The voltage drops to about 9.5 volts (e.g., almost immediately after the load is applied). The load is then removed and the battery is shown recovering to a voltage of about 11.4 volts between about 45 and 60 seconds. The drop in voltage from the start voltage is about 2.1 volts (e.g., 11.6−9.5=2.1 volts). Since the voltage drop is more than the preferred predetermined value of 0.5 volts, routine 120 may continue to apply additional loads, determine that the load was properly applied during the load test, and/or begin routines 140a and/or 140b shown on FIGS. 5A and 5B to determine whether the battery was properly charged during the load test (step 132 on FIG. 2).

Between about 60 and 90 seconds, a relatively heavy load (e.g., 150 amps) is applied to the battery. During this period, the voltage of the battery is shown decreasing (shown as a “well”) from a start voltage of about 11.4 volts (e.g., at about 60 seconds). The voltage drops to about 9.3 volts (e.g., immediately after the load is applied). The load is then removed and the battery is shown recovering to a voltage of about 11.3 volts between about 75 and 90 seconds. The drop in voltage from the start voltage is about 2.1 volts (e.g., 11.4−9.3=2.1 volts). Since the voltage drop is more than the preferred predetermined value of 0.5 volts, routine 120 may continue to apply additional loads, determine that the load was properly applied during the load test, and/or begin routines 140a and/or 140b shown on FIGS. 5A and 5B to determine whether the battery was properly charged during the load test (step 132 on FIG. 2).

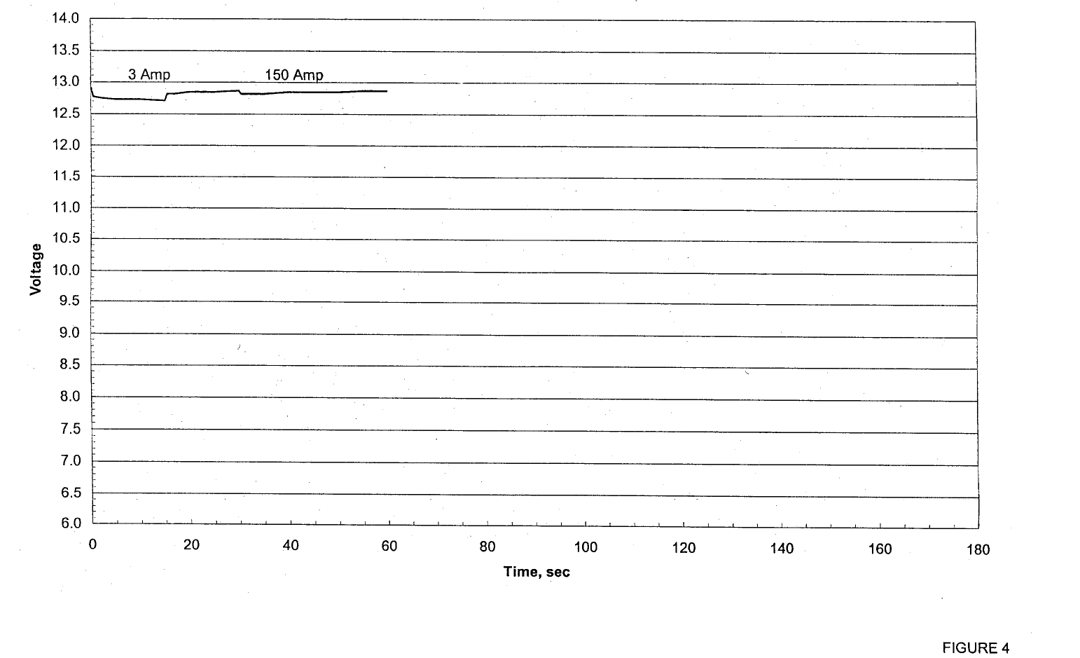

FIG. 4 provides an example of how routine 120 from FIG. 2 may be carried out on a battery. Referring to FIG. 4, a battery is shown undergoing charging and discharging from a battery charger-tester. A relatively light load (e.g., 3 amps) is applied to the battery at 0 to about 15 seconds. The voltage of the battery is shown dropping to about 12.7 volts from a start voltage of about 12.9 volts. The battery is shown recovering to a voltage of about 12.9 volts between about 15 and 30 seconds. The voltage drops about 0.2 volts (e.g., 12.9−12.7=0.2 volts). Since the voltage drop is less than the preferred predetermined value of 0.5 volts, routine 120 (shown in FIG. 2) would return to the beginning to measure the start voltage so that additional loads could be applied for additional testing.

Between about 30 and 60 seconds, a relatively heavy load (e.g., 150 amps) is applied to the battery. During this period, the voltage of the battery is shown to be relatively constant at a voltage of about 12.8 volts despite the application of a load (e.g., at about 30 to 45 seconds). The voltage also remains relatively constant at about 12.8 volts after the load is removed (e.g., at about 45 to 60 seconds). Since the voltage drop from the start voltage of 12.8 volts was not more than the preferred predetermined value of 0.5 volts (e.g., 12.8−12.8=0), routine 120 may return the beginning to measure start voltage and reapply a load for further testing or stop the load test altogether and determine that the load was not properly applied (step 134 on FIG. 2).

FIG. 5A shows a flow diagram of a routine or test 140a to determine whether a charging current is properly applied during charging of a battery according to an exemplary embodiment. According to routine 140a, the battery is charged (e.g., a long or short charge before or after a load test) with a charging current (step 142a). The control system monitors the charging current and the voltage of the battery (step 144a). The control system determines whether the charging current is less than a first predetermined current value (step 146a). According to various exemplary embodiments, the first predetermined current value may be less than about 50 amps and suitably less than about 10 amps. According to a preferred embodiment, the first predetermined current value is about 1.0 amps. If the charging current is not less than the first predetermined current value, then charging of the battery continues (step 142a). If the charging current is less than the first predetermined current value, then the control system determines whether the voltage of the battery decreases by more than a first predetermined voltage value in a predetermined time frame (step 148a). According to various exemplary embodiments, the first predetermined voltage value may be less than about 5.0 volts and suitably less than about 2 volts. According to a preferred embodiment, the first predetermined voltage value is about 0.5 volts. According to exemplary embodiments, the first predetermined time frame may be less than about five minutes and suitably less than about three minutes. According to a preferred embodiment, the predetermined time frame is about 1 minute. If the voltage of the battery decreases by more than the first predetermined voltage in the predetermined time frame, the charging has failed and charging of the battery continues (step 142a) or stops if a return to the beginning of routine 140a is required more than once. If the voltage of the battery does not decrease by more than a first predetermined value in a predetermined time frame, then the control system concludes that the charging of the battery (step 142a) was complete and that the battery was properly charged (step 154a).

FIG. 5B shows a flow diagram of a routine 140b to determine whether a charging current was properly applied during charging of the battery, according to an alternative embodiment. According to routine 140b, the battery is charged (step 142b). The control system monitors the charging current and the voltage of the battery (step 144b). The control system determines whether the charging current drops more than a second predetermined current value (step 146b). According to various embodiments, the second predetermined current value may be less than about 5.0 amps. According to a preferred embodiment, the second predetermined value is about 1.0 amps. If the charging current does not drop more than the second predetermined current value, then charging of the battery continues (step 142b). If the charging current drops more than the second predetermined current value, then the control system determines whether the voltage of the battery is greater than a second predetermined voltage value (step 148a). According to exemplary embodiments, the second predetermined voltage value may be in the range of about 12 to 16 volts. According to a preferred embodiment, the second predetermined voltage value is about 14.5 volts. If the voltage of the battery is not greater than the second predetermined voltage value, then the control system determines that the charging of the battery (step 142b) “failed” or was incomplete (step 150b), and charging of the battery continues or stops if more than one cycle back to the beginning of routine 140b is required. If the voltage of the battery is more than the second predetermined voltage value during this period, then the control system determines that the charging of the battery (step 142b) was complete and that the battery was properly charged (step 154b).

FIG. 5C shows a flow diagram of a routine 140c to determine whether a charging current was properly applied during an initial charging of the battery, according to an alternative embodiment. According to routine 140c, the battery is charged (step 142c). The control system monitors the charging current to determine when (or if) a current is applied to the battery (step 144c). The control system determines whether the voltage increased from an initial voltage (e.g., when the current is first applied to the battery) by more than a third predetermined voltage value (step 146c). According to various embodiments, the third predetermined voltage value may be less than about 5.0 volts. According to a preferred embodiment, the third predetermined voltage value is about 0.5 volts. If the voltage does not increase by more than the third predetermined voltage value, then charging of the battery continues (step 142c). If the voltage of the battery increases by more than the third predetermined voltage value, then the control system determines that the charging of the battery (step 142c) was complete and that the battery was properly charged (step 148c).

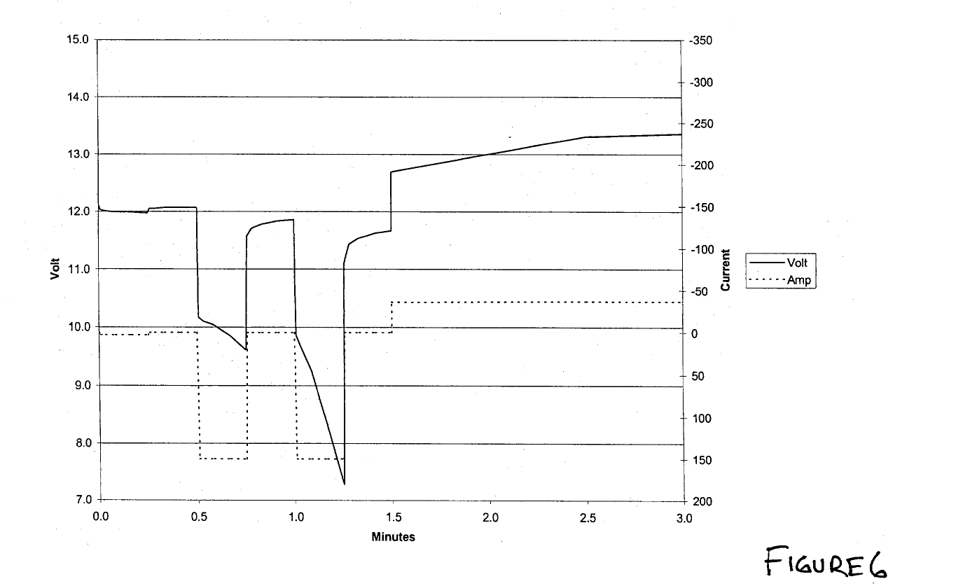

FIG. 6 provides an example of how routine 140c from FIG. 5C may be carried out on a battery. The battery is first provided with a charging current at about 1.5 minutes as indicated by the negative current. The voltage is shown increasing from about 11.5 volts to about 12.7 volts. Since the voltage increased by more than the third predetermined voltage value (e.g., more than 0.5 volts), the control system would determine that the battery was properly charged (step 148c from FIG. 5C). If the voltage had not increased by more than the third predetermined voltage value, the control system would determine that the battery charging had failed (step 150c).

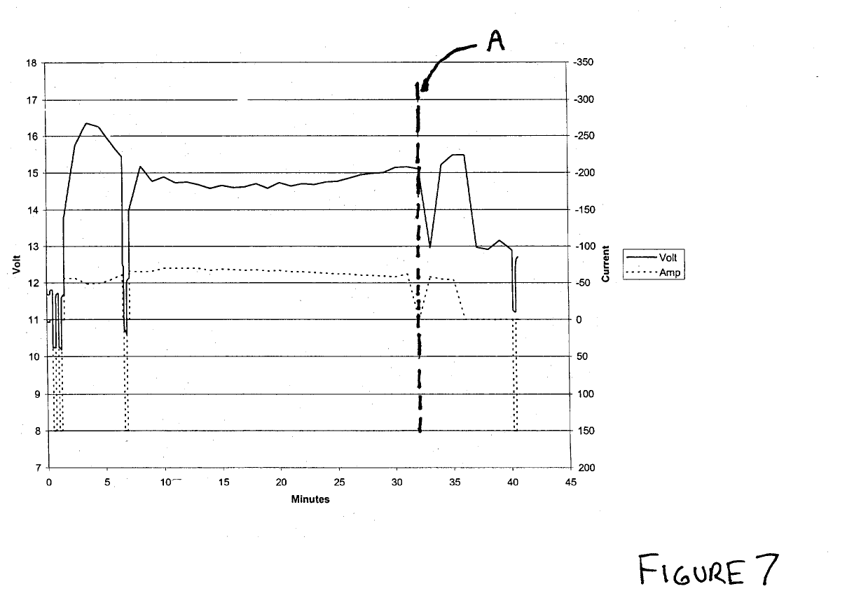

FIG. 7 provides an example of how routines 140a and 140b from FIGS. 5A and 5B, respectively can be used to indicate improper charging (e.g., failure) in a charging circuit. Referring to FIG. 7, the failure would be identified at about 32 minutes (e.g., line A shown on FIG. 7). Applying routine 140a from FIG. 5A, the charge current is less than a first predetermined current value (e.g., 1.0 amps) at about 32 minutes. In addition, the voltage decreased by more than a first predetermined voltage value (e.g., 0.5 volts) in a first predetermined time frame (e.g., 1.0 minute). Accordingly, the control system would determine that the charging failed.

Applying routine 140b from FIG. 5B, the charge current drops by more than a second predetermined current value (e.g., 1.0 amp) at about 32 minutes (e.g., at line A on FIG. 7). In addition, the voltage is not greater than a second predetermined voltage value (e.g., 14.5 volts). Accordingly, the control system would determine that the charging failed.

It is important to note that the above-described embodiments are illustrative only. Although the invention has been described in conjunction with specific embodiments thereof, those skilled in the art will appreciate that numerous modifications are possible without materially departing from the novel teachings and advantages of the subject matter described herein. Accordingly, all other such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present invention.

What is claimed is:

1. A method for determining whether a battery load test was properly carried out for a battery, the method comprising:
determining whether a load was properly applied to the battery during the load test; and
determining whether the battery was properly charged during the load test.

2. The method of claim 1, wherein determining whether the load was properly applied during the load test comprises:
measuring a start voltage of a battery;
applying a load to the battery during a load test period;
measuring a voltage drop once the load is applied to the battery;
removing the load from the battery; and
determining whether the voltage drop is greater than a predetermined value.

3. The method of claim 2, further comprising determining that the load was properly applied during the load test if the voltage drop is greater than a value in the range of about 0 to 5.0 volts.

4. The method of claim 3, further comprising determining that the load was properly applied during the load test if the voltage drop is greater than about 0.5 volts.

5. The method of claim 2, further comprising determining that the load was not properly applied during the load test if the voltage drop is not greater than about 0.5 volts.

6. The method of claim 2, wherein the start voltage comprises the voltage of the battery immediately before the load is applied.

7. The method of claim 6, wherein measuring the voltage drop comprises finding the difference between the start voltage and the voltage of the battery just after the load is applied.

8. The method of claim 1, wherein determining that the battery was properly charged during the load test comprises:
charging the battery with a charging current;
determining that the charging current is less than a first predetermined current value; and
determining that the voltage of the battery does not decrease by more than a first predetermined voltage value in a first predetermined time frame.

9. The method of claim 8, wherein the first predetermined current value is less than about 50 amps, the first predetermined voltage value is less than about 5 volts, and the first predetermined time frame is less than about 5 minutes.

10. The method of claim 9, wherein the first predetermined current value is about 1.0 amp, the first predetermined voltage value is about 0.5 amps, and the first predetermined time frame is about 1.0 minute.

11. The method of claim 1, wherein determining that the battery was properly charged during the load test comprises:
charging the battery with a charging current;
determining that the charging current drops by more than a second predetermined current value;
determining that the voltage of the battery is greater than a second predetermined voltage value.

12. The method of claim 11, wherein the second predetermined current value is less than about 5 amps and the second predetermined voltage value is in the range of about 12 to 16 volts.

13. The method of claim 12, wherein the second predetermined current value is about 1.0 amp and the second predetermined voltage value is about 14.5 volts.

14. The method of claim 1, wherein determining that the battery was properly charged during the load test comprises:
charging the battery with a charging current;
determining that the charging current is applied to the battery;
determining that the voltage of the battery increases by more than a third predetermined current value.

15. The method of claim 14, wherein the third predetermined voltage value is in the range of about 0 to 5.0 volts.

16. The method of claim 15, wherein the third predetermined voltage value is about 0.5 volts.

17. An apparatus for analyzing a battery load test, comprising:
a tester for conducting a series of tests on a battery;
a charger for providing a charging current to the battery; and
a control system having a routine for determining whether a load was properly applied to a battery during the load test and whether the battery was properly charged during the load test.

18. The apparatus of claim 17, wherein the tester conducts one or more tests on the battery by applying a load to the battery.

19. The apparatus of claim 18, wherein the one or more tests may include a conductance test, a heavy load test, a light load test, a conductance and load comparison test, and a charge acceptance test.

20. The apparatus of claim 19, wherein the charger provides a complete charging current when the battery passes one or more of the tests.

21. The apparatus of claim 19, wherein the charger does not provide a complete charging current when the battery fails one or more of the tests.

22. The apparatus of claim 19, wherein the control system is adapted to find the battery load test invalid where the battery fails one or more of the tests.

23. The apparatus of claim 17, wherein the routine of the control system comprises:
measuring a start voltage of a battery;
controlling the application of a load to the battery;
monitoring the voltage drop once the load is applied to the battery;
controlling the removal of the load from the battery;
monitoring the recovery voltage of the battery by a sensor of the control system after the load is removed; and
determining whether the voltage drop is greater than a predetermined value.

24. The apparatus of claim 23, wherein the control system provides output relating to the battery and the tests performed on the battery.

25. The apparatus of claim 23, wherein the routine further comprises determining that the load was properly applied during the load test if the voltage drop is greater than a value in the range of about 0 to 5.0 volts.

26. The apparatus of claim 23, wherein the routine further comprises determining that the load was properly applied during the load test if the voltage drop is greater than about 0.5 volts.

27. The apparatus of claim 17, wherein the routine of the control system determines that the battery was properly charged when the charging current is less than a first predetermined current value and the voltage of the battery does not decrease by more than a first predetermined voltage value in a first predetermined time frame.

28. The apparatus of claim 17, wherein the routine of the control system determines that the battery was properly charged when the charging current drops by more than a second predetermined current value and the voltage of the battery is greater than a second predetermined voltage value.

29. The apparatus of claim 17, wherein the routine of the control system determines that the battery was properly charged when the charging current is applied to the battery and the voltage of the battery increases by more than a third predetermined current value.
